(19) United States
(12) Patent Application Publication
(10) Pub. No.: US 2014/0120016 A1
(43) Pub. Date: May 1, 2014

(54) METHOD FOR ABSORPTION OF CO2 FROM A GAS MIXTURE

(71) Applicants: Jörn Rolker, Alzenau (DE); Matthias Seiler, Griesheim (DE); Rolf Schneider, Gründau-Rothenbergen (DE)

(72) Inventors: Jörn Rolker, Alzenau (DE); Matthias Seiler, Griesheim (DE); Rolf Schneider, Gründau-Rothenbergen (DE)

(73) Assignee: Evonik Degussa GmbH, Essen (DE)

(21) Appl. No.: 14/124,347

(22) PCT Filed: May 25, 2012
(86) PCT No.: PCT/EP2012/059818

§ 371 Date: Dec. 6, 2013

(30) Foreign Application Priority Data
Jun. 10, 2011 (EP) 11169501.1

(51) Int. Cl. B01D 53/62

(52) U.S. Cl. CPC B01D 53/62
USPC 423/228

(57) ABSTRACT

A method of absorbing CO₂ from a gas mixture by bringing the gas mixture into contact with an absorption medium comprising water and an amine of formula (I)

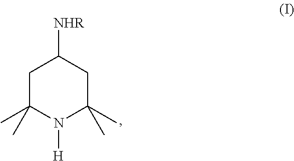

where R is an n-alkyl radical having from 1 to 4 carbon atoms, at an initial partial pressure of CO₂ of from 0.01 to 0.6 bar, can be operated without precipitation of a solid during the absorption of CO₂.

The invention relates to a method of absorbing CO₂ from a gas mixture, in particular from a combustion off-gas.

Gas streams which have an undesirable high content of CO₂ which has to be reduced for further processing, for transport or for avoiding CO₂ emissions occur in numerous industrial and chemical processes.

On the industrial scale, CO₂ is typically absorbed from a gas mixture by using aqueous solutions of alkanolamines as an absorption medium. The loaded absorption medium is regenerated by heating, depressurization to a lower pressure or stripping, and the carbon dioxide is desorbed. After the regeneration process, the absorption medium can be used again. These methods are described for example in Rolker, J.; Arlt, W.; “Abtrennung von Kohlendioxid aus Rauchgasen mittels Absorption” [Removal of carbon dioxide from flue gases by absorption] in Chemie Ingenieur Technik 2006, 78, pages 416 to 424, and also in Kohl, A. L.; Nielsen, R. B., “Gas Purification”, 5th edition, Gulf Publishing, Houston 1997.

A disadvantage of these methods, however, is that the removal of CO₂ by absorption and subsequent desorption requires a relatively large amount of energy and that, on desorption, only a part of the absorbed CO₂ is desorbed again, with the consequence that, in a cycle of absorption and desorption, the capacity of the absorption medium is not sufficient.

U.S. Pat. No. 7,419,646 describes a process for deacidifying off-gases in which an absorption medium is used which forms two separable phases upon absorption of the acid gas. 4-Amino-2,2,6,6-tetramethylpiperidine is cited, inter alia, in column 6 as a reactive compound for absorbing an acid gas. The process of U.S. Pat. No. 7,419,646 has the disadvantage that additional apparatus is required for separating the two phases which arise in the absorption.

US 2009/0199709 describes a similar method, in which, following absorption of the acid gas, heating of the loaded absorption medium produces two separable phases which are then separated from one another. Here again, 4-amino-2,2,6,6-tetramethylpiperidine is cited as a reactive compound suitable for the absorption of an acid gas.

FR 2900841 and US 2007/0286783 describe methods for deacidifying off-gases, in which the reactive compound reacted with CO₂ is separated from the loaded absorption medium by extraction. One of the reactive compounds cited for the absorption of an acid gas is 4-amino-2,2,6,6-tetramethylpiperidine.

WO 2010/089257 describes a method for absorbing CO₂ from a gas mixture using an absorption medium that comprises water and a 4-amino-2,2,6,6-tetramethylpiperidine, which amine can be alkylated on the 4-amino group. However, in the case of absorption media which contain 4-amino-2,2,6,6-tetramethylpiperidine as absorption agent, precipitation of the carbamate salt can easily occur in the absorption of CO₂. WO 2010/089257 describes the addition of solvents, such as sulfolane or ionic liquids, in order to maintain the absorption medium single phase and to achieve a higher absorption capacity for CO₂.

Therefore, there is still a need for a method of absorbing CO₂ from a gas mixture, which method is suitable for absorbing CO₂ from combustion off-gases and by means of which a high absorption capacity for CO₂ can be achieved, with separation into two liquid phases or precipitation of a solid being prevented during the absorption of CO₂ by the method even without addition of a solvent.

It has now been found that this object can be achieved by using as reactive compound for the absorption of CO₂ a 4-amino-2,2,6,6-tetramethylpiperidine having a methyl, ethyl, n-propyl or n-butyl substituent on the 4-amino group and by keeping the CO₂ partial pressure of the gas mixture used in the range from 0.01 to 0.6 bar.

The invention therefore provides a method of absorbing CO₂ from a gas mixture by bringing the gas mixture into contact with an absorption medium comprising water and an amine of formula (I)

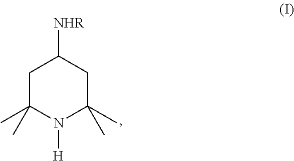

where R is an n-alkyl radical having from 1 to 4 carbon atoms, at an initial partial pressure of CO₂ of from 0.01 to 0.6 bar, with the absorption medium not comprising any amine having more than two nitrogen atoms.

The absorption medium used in the method of the invention comprises water and an amine of formula (I), where R is an n-alkyl radical having from 1 to 4 carbon atoms. R can thus be a methyl radical, an ethyl radical, an n-propyl radical or an n-butyl radical. R is preferably an n-propyl radical or an n-butyl radical, particularly preferably an n-butyl radical. Amines of formula (I) can be prepared from commercial triacetone amine by reductive amination, i.e. by reacting triacetone amine with an amine of formula RNH₂ and hydrogen in the presence of a hydrogenation catalyst. The absorption medium preferably comprises from 10 to 50% by weight, particularly preferably from 15 to 30% by weight, of amines of formula (I).

In addition to water and amines of formula (I), the absorption medium may further comprise one or more physical solvents. The proportion of physical solvents in this case may be up to 50% by weight. Suitable physical solvents include sulfolane, aliphatic acid amides, such as N-formylmorpholine, N-acetylmorpholine, N-alkylpyrrolidones, more particularly N-methyl-2-pyrrolidone, or N-alkylpiperidones, and also diethylene glycol, triethylene glycol and polyethylene glycols and alkyl ethers thereof, more particularly diethylene glycol monobutyl ether. Preferably, however, the absorption medium contains no physical solvent.

The absorption medium may additionally comprise further additives, such as corrosion inhibitors, wetting-promoting additives and defoamers.

All compounds known to the skilled person as suitable corrosion inhibitors for the absorption of CO₂ using alkanolamines can be used as corrosion inhibitors in the absorption medium of the invention, in particular the corrosion inhibitors described in U.S. Pat. No. 4,714,597. In the method of the invention, a significantly lower amount of corrosion inhibitors can be chosen than in the case of a customary absorption medium containing ethanolamine, since the absorption medium used in the method of the invention is significantly less corrosive towards metallic materials than the customarily used absorption media that contain ethanolamine.

The cationic surfactants, zwitterionic surfactants and nonionic surfactants known from WO 2010/089257 page 11, line 18 to page 13, line 7 are preferably used as wetting-promoting additive.

All compounds known to the skilled person as suitable defoamers for the absorption of CO₂ using alkanolamines can be used as defoamers in the absorption medium.

In the method of the invention, a CO₂-containing gas mixture is brought into contact with the absorption medium at an initial partial pressure of CO₂ of from 0.01 to 0.6 bar. The initial partial pressure of CO₂ in the gas mixture is preferably from 0.05 to 0.6 bar, particularly preferably from 0.1 to 0.5 bar and most preferably from 0.1 to 0.2 bar. The overall pressure of the gas mixture is preferably in the range from 0.8 to 10 bar, particularly preferably 0.9 to 5 bar.

The gas mixture may be a natural gas, a methane-containing biogas from a fermentation, composting or a sewage treatment plant, a combustion off-gas, an off-gas from a calcination reaction, such as the burning of lime or the production of cement, a residual gas from a blast-furnace operation for producing iron, or a gas mixture resulting from a chemical reaction, such as, for example, a synthesis gas containing carbon monoxide and hydrogen, or a reaction gas from a steam-reforming hydrogen production process. The gas mixture is preferably a combustion off-gas or a gas mixture from the fermentation or composting of biomass, particularly preferably a combustion off-gas, for example from a power station.

The gas mixture can contain further acid gases, for example COS, H₂S, CH₃SH or SO₂, in addition to CO₂. In a preferred embodiment, the gas mixture contains H₂S in addition to CO₂. A combustion off-gas is preferably desulphurized beforehand, i.e. SO₂ is removed from the gas mixture by means of a desulphurization method known from the prior art, preferably by means of a gas scrub using milk of lime, before the absorption method of the invention is carried out.

Before being brought into contact with the absorption medium, the gas mixture preferably has a CO₂ content in the range from 0.1 to 50% by volume, particularly preferably in the range from 1 to 20% by volume, and most preferably in the range from 10 to 20% by volume.

The gas mixture can contain oxygen, preferably in a proportion of from 0.1 to 25% by volume and particularly preferably in a proportion of from 0.1 to 10% by volume, in addition to CO₂.

For the method of the invention, all apparatus suitable for contacting a gas phase with a liquid phase can be used to contact the gas mixture with the absorption medium. Preferably, absorption columns or gas scrubbers known from the prior art are used, for example membrane contactors, radial flow scrubbers, jet scrubbers, venturi scrubbers, rotary spray scrubbers, random packing columns, ordered packing columns or tray columns. With particular preference, absorption columns are used in countercurrent flow mode.

In the method of the invention, the absorption of CO₂ is carried out preferably at a temperature of the absorption medium in the range from 10 to 80° C., more preferably 20 to 50° C. When using an absorption column in countercurrent flow mode, the temperature of the absorption medium is more preferably 30 to 60° C. on entry into the column, and 35 to 70° C. on exit from the column.

In a preferred embodiment of the method of the invention, CO₂ absorbed in the absorption medium is desorbed again by increasing the temperature and/or reducing the pressure and the absorption medium after this desorption of CO₂ is used again for absorbing CO₂. The desorption is preferably carried out by increasing the temperature. By such cyclic operation of absorption and desorption, CO₂ can be entirely or partially separated from the gas mixture and obtained separately from other components of the gas mixture.

As an alternative to the increase in temperature or the reduction in pressure, or in addition to an increase in temperature and/or a reduction in pressure, it is also possible to carry out a desorption by stripping the absorption medium loaded with CO₂ by means of an inert gas, such as air or nitrogen.

If, in the desorption of CO₂, water is also removed from the absorption medium, water may be added as necessary to the absorption medium before reuse for absorption.

All apparatus known from the prior art for desorbing a gas from a liquid can be used for the desorption. The desorption is preferably carried out in a desorption column. Alternatively, the desorption of CO₂ may also be carried out in one or more flash evaporation stages.

The desorption is carried out preferably at a temperature in the range from 30 to 180° C. In a desorption by an increase in temperature, the desorption of CO₂ is carried out preferably at a temperature of the absorption medium in the range from 50 to 180° C., more preferably 80 to 150° C. The temperature during desorption is then preferably at least 20° C., more preferably at least 50° C., above the temperature during absorption.

Since the absorption medium used in the method of the invention has a high absorption capacity for CO₂ at an absorption rate which is sufficiently high for industrial use and is present as a homogeneous solution in the method of the invention without precipitation of a solid occurring on absorption of CO₂, the method of the invention can be used in plants having a simple construction and in such a case achieves an absorption performance for CO₂ which is improved compared to ethanolamine. At the same time, significantly less energy is required for desorption of CO₂ compared to the case of ethanolamine.

In a preferred embodiment of the method of the invention, the desorption is carried out by stripping with an inert gas such as air or nitrogen in a desorption column. The stripping in the desorption column is preferably carried out at a temperature of the absorption medium in the range from 60 to 100° C. Stripping enables a low residual content of CO₂ in the absorption medium to be achieved after desorption with a low energy consumption.

In a further embodiment, the composition of the absorption medium is selected so that demixing of the absorption agent loaded with CO₂ into an aqueous CO₂-rich liquid phase and an organic low-CO₂ liquid phase occurs when the temperature is increased for desorption. This allows regeneration at lower temperatures and a saving of energy in the regeneration as a result of only the CO₂-rich phase being regenerated and the low-CO₂ phase being recirculated directly to the absorption. In these cases, an energetically favourable flash step can be sufficient to regenerate the absorption agent loaded with CO₂.

The following examples illustrate the invention without, however, restricting the subject matter of the invention.

### EXAMPLES

The absorption media investigated are summarized in Table 1.

For determining the CO₂ loading, the CO₂ uptake and the relative absorption rate, 150 g of absorption medium were charged to a thermostatable container with a top-mounted reflux condenser cooled at 3° C. After heating to 40° C. or 100° C., a gas mixture of 14% CO₂, 80% nitrogen and 6% oxygen by volume was passed at a flow rate of 59 l/h through the absorption medium, via a frit at the bottom of the container, and the CO₂ concentration in the gas stream exiting the reflux condenser was determined by IR absorption using a CO₂ analyser. The difference between the CO₂ content in the gas stream introduced and in the exiting gas stream was integrated to give the amount of CO₂ taken up, and the equilibrium CO₂ loading of the absorption medium was calculated. The CO₂ uptake was calculated as the difference in the amounts of CO₂ taken up at 40° C. and at 100° C. From the slope of the curve of CO₂ concentration in the exiting gas stream for an increase in concentration from 1% to 12% by volume, a relative absorption rate of CO₂ in the absorption medium was determined. The equilibrium loadings determined in this way at 40° C. and 100° C., in mol CO₂/mol amine, the CO₂ uptake in mol CO₂/kg absorption medium, and the relative absorption rate of CO₂, relative to Example 1 with 100%, are given in Table 1.

In Example 2, the CO₂ loading at 40° C. resulted in the precipitation of the carbamate salt of TAD (4-amino-2,2,6,6-tetramethylpiperidine).

TABLE 1

| | Example | | | | |
|---|---|---|---|---|---|
| | 1* | 2* | 3 | 4 | 5 |
| Proportions in % by weight | | | | | |
| Water | 70 | 70 | 70 | 70 | 70 |
| MEA | 30 | 0 | 0 | 0 | 0 |
| TAD | 0 | 30 | 0 | 0 | 0 |
| Me-TAD | 0 | 0 | 30 | 0 | 0 |
| Pr-TAD | 0 | 0 | 0 | 30 | 0 |
| Bu-TAD | 0 | 0 | 0 | 0 | 30 |
| Loading at 40° C. in mol/mol | 0.45 | 1.08 | ** | 1.53 | 1.38 |
| Loading at 100° C. in mol/mol | 0.22 | 0.54 | ** | 0.39 | 0.20 |
| CO₂ uptake in mol/kg | 1.15 | 1.04 | ** | 1.71 | 1.66 |
| Relative absorption rate in % | 100 | 178 | ** | 41 | 50 |

*not according to the invention
** solid precipitated during introduction of gas
MEA: ethanolamine
TAD: 4-amino-2,2,6,6-tetramethylpiperidine
Me-TAD: 4-methylamino-2,2,6,6-tetramethylpiperidine
Pr-TAD: 4-(n-propylamino)-2,2,6,6-tetramethylpiperidine
Bu-TAD: 4-(n-butylamino)-2,2,6,6-tetramethylpiperidine

The examples carried out at a CO₂ partial pressure of 0.14 bar show that a higher CO₂ uptake can be achieved by means of the method of the invention than in the case of methods using ethanolamine or TAD for the absorption.

To determine the CO₂ partial pressure above which precipitation of a solid occurs on absorption, absorption medium having the composition shown in Table 2 was charged to a thermostatable container with a top-mounted reflux condenser cooled at 3° C. After heating to 40° C., a gas mixture of CO₂ and nitrogen was passed through the absorption medium at 1 bar via a frit for 2 hours, using gas mixtures containing 20, 40, 60 and 80% by volume of CO₂ in order to set CO₂ partial pressures of from 0.2 to 0.8 bar in the gas mixture fed in. Table 2 summarizes the experiments in which precipitation of solid was observed.

In addition, in the case of the working medium from Example 2, an experiment was carried out in which 250 g of working medium were charged at 40° C. in a thermostated 500 ml autoclave and, after evacuation, CO₂ was introduced under pressure regulation to saturation, with the pressure being increased stepwise to set CO₂ partial pressures of 75 mbar, 90 mbar and 100 mbar. At a CO₂ partial pressure of 100 mbar, precipitation of solid was observed.

TABLE 2

| | Example | | | | | | | | | |
|---|---|---|---|---|---|---|---|---|---|---|
| | 2* | 3 | 6 | 7 | 4 | 8 | 9 | 5 | 10 | 11 |
| Proportions in | | | | | | | | | | |
| % by weight | | | | | | | | | | |
| Water | 70 | 70 | 60 | 50 | 70 | 60 | 50 | 70 | 60 | 50 |
| TAD | 30 | 0 | 0 | 0 | 0 | 0 | 0 | 0 | 0 | 0 |
| Me-TAD | 0 | 30 | 40 | 50 | 0 | 0 | 0 | 0 | 0 | 0 |
| Pr-TAD | 0 | 0 | 0 | 0 | 30 | 40 | 50 | 0 | 0 | 0 |
| Bu-TAD | 0 | 0 | 0 | 0 | 0 | 0 | 0 | 30 | 40 | 50 |
| Solid precipitation | | | | | | | | | | |
| at CO₂ content | | | | | | | | | | |
| 20 vol % | yes | no | no | yes | no | yes | yes | no | no | no |
| 40 vol % | yes | yes | yes | yes | yes | yes | yes | no | no | no |
| 60 vol % | yes | yes | yes | yes | yes | yes | yes | no | no | no |
| 80 vol % | yes | yes | yes | yes | yes | yes | yes | yes | yes | yes |

*not according to the invention

1-12. (canceled)

13. A method of absorbing CO₂ from a gas mixture, comprising contacting the gas mixture with an absorption medium at an initial partial pressure of CO₂ of from 0.01 to 0.6 bar, wherein the absorption medium comprises water and an amine of formula (I): 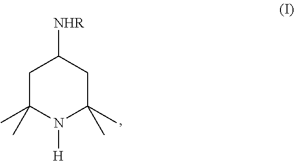
wherein R is an n-alkyl radical having from 1 to 4 carbon atoms, and wherein the absorption medium does not comprise an amine having more than two nitrogen atoms.

14. The method of claim 13, wherein R is an n-butyl radical.

15. The method of claim 13, wherein the initial partial pressure of CO₂ in the gas mixture is from 0.1 to 0.5 bar.

16. The method of claim 13, wherein the initial proportion of CO₂ in the gas mixture is from 0.1 to 50% by volume.

17. The method of claims 13, wherein the gas mixture contains from 0.1 to 25% by volume of oxygen.

18. The method of claim 13, wherein the gas mixture is a combustion off-gas.

19. The method of claim 13, wherein the gas mixture originates from the fermentation or composting of biomass.

20. The method of claim 13, wherein the absorption medium comprises from 10 to 50% by weight of an amine of formula (I).

21. The method of claim 13, wherein the absorption medium contains no solvent.

22. The method of claim 13, wherein CO₂ absorbed in the absorption medium is desorbed by increasing the temperature and/or reducing the pressure and, after this desorption of CO₂, the absorption medium is used again for absorbing CO₂.

23. The method of claim 22, wherein the absorption is carried out at a temperature in the range of from 10 to 80° C. and the desorption is carried out at a temperature in the range of from 30 to 180° C.

24. The method of claim 22, wherein absorption medium loaded with CO₂ is stripped with an inert gas to effect desorption.

25. The method of claim 15, wherein the initial proportion of CO₂ in the gas mixture is from 0.1 to 50% by volume.

26. The method of claim 25, wherein the gas mixture contains from 0.1 to 25% by volume of oxygen.

27. The method of claim 26, wherein the absorption medium comprises from 10 to 50% by weight of an amine of formula (I).

28. The method according of claim 27, wherein the absorption medium contains no solvent.

29. The method of claim 28, wherein CO₂ absorbed in the absorption medium is desorbed by increasing the temperature and/or reducing the pressure, and, after the desorption of CO₂, the absorption medium is used again for absorbing CO₂.

30. The method of claim 29, wherein the absorption is carried out at a temperature in the range of from 10 to 80° C. and the desorption is carried out at a temperature in the range of from 30 to 180° C.

31. The method of claim 30, wherein absorption medium loaded with CO₂ is stripped with an inert gas to effect desorption.

32. The method of claim 31, wherein R in the amine of formula (I) is an n-butyl radical.
